(19) United States
(12) Patent Application Publication
(10) Pub. No.: US 2012/0163818 A1
(43) Pub. Date: Jun. 28, 2012

(54) PASSIVE OPTICAL NETWORK APPARATUS FOR TRANSMITTING OPTICAL SIGNAL

(75) Inventors: Dong Soo LEE, Gwangju-si (KR); Jong Deog KIM, Daejeon-si (KR); Sung Chang KIM, Gwangju-si (KR); Hark YOO, Gwangju-si (KR); Mun Seob LEE, Daejeon-si (KR); Geun Yong KIM, Goyang-si (KR); Young Suk LEE, Gwangju-si (KR); Sim Kwon YOON, Gwangju-si (KR); Sang Soo LEE, Daejeon-si (KR); Han Hyub LEE, Daejeon-si (KR)

(73) Assignee: Electronics and Telecommunications Research Institute, Daejeon-si (KR)

(21) Appl. No.: 13/280,103

(22) Filed: Oct. 24, 2011

(30) Foreign Application Priority Data
Dec. 28, 2010 (KR) 10-2010-0136163

(51) Int. Cl. H04J 14/02; H04J 14/08

(52) U.S. Cl. 398/67

(57) ABSTRACT

Disclosed herein are a remote node and a telephone station terminal in a passive optical network (PON). The remote node includes an optical circulator that transmits downlink signals input from a downlink optical backbone network to a wavelength distributor and transmits uplink signals input from the wavelength distributor to an uplink optical backbone network different from a downlink optical backbone network; and a wavelength distributor that distributes the downlink signal input from the optical circulator into a plurality of wavelengths to be connected to an optical distribution network and connects the uplink signals input from the optical distribution network to the optical circulator.

### CROSS-REFERENCE TO RELATED APPLICATIONS

This application claims the benefit of priority of Korean Patent application No. 10-2010-0136163 filed on Dec. 28, 2010, which is incorporated by reference in its entirety herein.

### BACKGROUND OF THE INVENTION

1. Field of the Invention

The present invention relates to an optical network, and more particularly, to a passive optical network (PON) apparatus for transmitting or receiving optical signals and a PON using the same.

2. Related Art

A passive optical network (PON) corresponds to a one-to-many network architecture using an optical distributor in order for a single optical fiber to which power is not supplied to support multiple subscribers. The PON corresponds to a fiber to the premises (FTTP) network structure since most networks are configured of an optical fiber. The PON includes an optical line terminal (OLT) of a service provider side and a plurality of optical network terminals of a subscriber side. The PON may reduce the optical fiber and the number of apparatuses on the service provider side, as compared with a one-to-one network.

During a transmission of signals to multiple subscribers from the PON, various types of multiplexing methods may be applied. A time division multiplexing (TDM) scheme allocates downlink signals or uplink signals to each subscriber at different time intervals so as to be transmitted. The PON in the TDM scheme may be implemented by various modes such as asynchronous transfer mode (ATM)-PON, broadband PON (BPON), gigabit PON (GPON), ethernet PON (EPON), or the like. Up to now, a technology capable of implementing 1 Gb/s transmission rate has been commercialized. In the future, a working for standardizing a PON capable of implementing 10 Gb/s transmission rate is in progress. A wavelength division multiplexing (WDM) scheme allocates downlink signals or uplink signals to each subscriber at different wavelengths so as to be transmitted. The PON according to the WDM scheme may implement 100 MB/s transmission rate per wavelength at an early stage but implements 1 Gb/s transmission rate per wavelength. In addition, the PON according to the WDM scheme generally uses different wavelengths of uplink signal and downlink signal for each subscriber, but may also use a remodulation method that reuses downlink optical signals as a light source to generate an uplink optical signal as a method of saving costs by reducing the number of light sources. The remodulation method refers to “Demonstration of Data Remodulation for Upstream Traffic in WDM Access Networks using Injection-Locked FP Laser as Modulator” by L. Y. Chan, 2001. Low-speed modulated uplink optical signals of 1 Gb/s may be generated based on high-speed modulated downlink optical signals of 10 Gb/s by applying the remodulation method.

The PON in the TDM scheme and the PON in the WDM scheme have a trade-off relationship with each other when considering characteristics of each scheme. That is, the advantages of the TDM scheme become the disadvantages of the WDM scheme, and vice versa. Therefore, a need exists for a more efficient PON architecture in which the TDM scheme is appropriately combined with the WDM scheme.

### SUMMARY OF THE INVENTION

The present invention provides a passive optical network (PON) apparatus for transmitting and receiving optical signals and a PON using the same.

In an aspect, a remote node in a passive optical network (PON) includes: an optical circulator that transmits downlink signals input from a downlink optical backbone network to a wavelength distributor and transmits uplink signals input from the wavelength distributor to a downlink optical backbone network different from the uplink optical backbone network; and a wavelength distributor that distributes the downlink signal input from the optical circulator into a plurality of wavelengths to be connected to an optical distribution network and connects the uplink signals input from the optical distribution network to the optical circulator.

The optical circulator may block the downlink signals input from the downlink optical backbone network from being input to a receiver of a telephone station terminal, and block the uplink signals input from the wavelength distributor from being input to a transmitter of the telephone station terminal.

The downlink signal may be generated by multiplexing a plurality of downlink signals by a time division multiplexing (TDM) scheme.

The downlink signal may be modulated simultaneously with a plurality of optical signals.

The uplink signal may be generated by multiplexing a plurality of uplink signals by a wavelength division multiple access (WDMA) scheme.

In another aspect of the present invention, a telephone station terminal in a passive optical network includes: a transmitter and a receiver, wherein the transmitter includes an electrical time division multiplexer that multiplexes a plurality of downlink signals into a high-speed single signal by a time division multiplexing (TDM) scheme and an optical modulator that modulates a plurality of optical signals simultaneously with the single signal to be output to a downlink optical backbone network, and the receiver includes a wavelength division demultiplexer that demultiplexes the uplink signals input from the uplink optical backbone network for each wavelength and a plurality of optical receivers that convert the demultiplexed uplink signals into a plurality of electrical signals, respectively.

The transmitter of the telephone station terminal may further include a wavelength division multiplexer that multiplexes the plurality of optical signals by a wavelength division multiplexing (WDM) scheme to be output to the optical modulator.

The wavelength division multiplexer may use an arrayed wave guide (AWG).

The wavelength division multiplexer is connected to the optical modulator through a WDM light source array including a single multiplexing output port.

The plurality of light sources, the wavelength division multiplexer, and the optical modulator may be integrated on a planar lightwave circuit (PLC) platform.

The transmitter of the telephone station terminal may further include an optical amplifier that amplifies the downlink signals output to the downlink optical backbone network.

The wavelength division demultiplexer of the receiver of the telephone station terminal may use the AWG.

The receiver of the telephone station terminal may be integrated on the PLC platform by a plurality of photo detectors (PDs).

The receiver of the telephone station terminal may further include an optical amplifier that amplifies the uplink signals input from the uplink optical backbone network.

### BRIEF DESCRIPTION OF THE DRAWINGS

FIG. 1 is a block diagram showing a general passive optical network (PON).

FIG. 2 is a block diagram showing the PON multiplexing signals by a time division multiplexing (TDM) scheme.

FIG. 3 is a block diagram showing the PON multiplexing signals by a wavelength division multiplexing (WDM) scheme.

FIG. 4 is a block diagram showing the PON multiplexing signals by the TDM scheme and the WDM scheme.

FIG. 5 is an example of a PON apparatus for transmitting optical signals according to the above proposed exemplary embodiments.

### DESCRIPTION OF EXEMPLARY EMBODIMENTS

Hereinafter, exemplary embodiments of the present invention will be described in detail with reference to the accompanying drawings, which will fully convey the concept of the invention to those skilled in the art. Moreover, detailed descriptions related to well-known functions or configurations will be ruled out in order not to unnecessarily obscure the subject matter of the present invention. It is also noted that like reference numerals denote like elements throughout the drawings.

In addition, unless explicitly described to the contrary, in the specification and the claims, the word “comprise” and variations such as “comprises” or “comprising,” will be understood to imply the inclusion of stated elements but not the exclusion of any other elements.

The present invention relates to a passive optical network (PON) apparatus for transmitting signals between an optical line terminal (OLT) of a telephone station terminal and an optical network terminal (ONT) of a subscriber terminal or an optical network unit (ONU) in an optical network. In more detail, according to the PON apparatus of the exemplary embodiment of the present invention, data transmitted to each subscriber, that is, downlink signals transmitted from the OLT to the ONT/ONU are multiplexed and transmitted by a time division multiplexing (TDM) scheme and signals transmitted from each subscriber, that is, uplink signals transmitted from the ONT/ONU to the OLT are divided and transmitted by a wavelength division multiple access (WDMA) scheme.

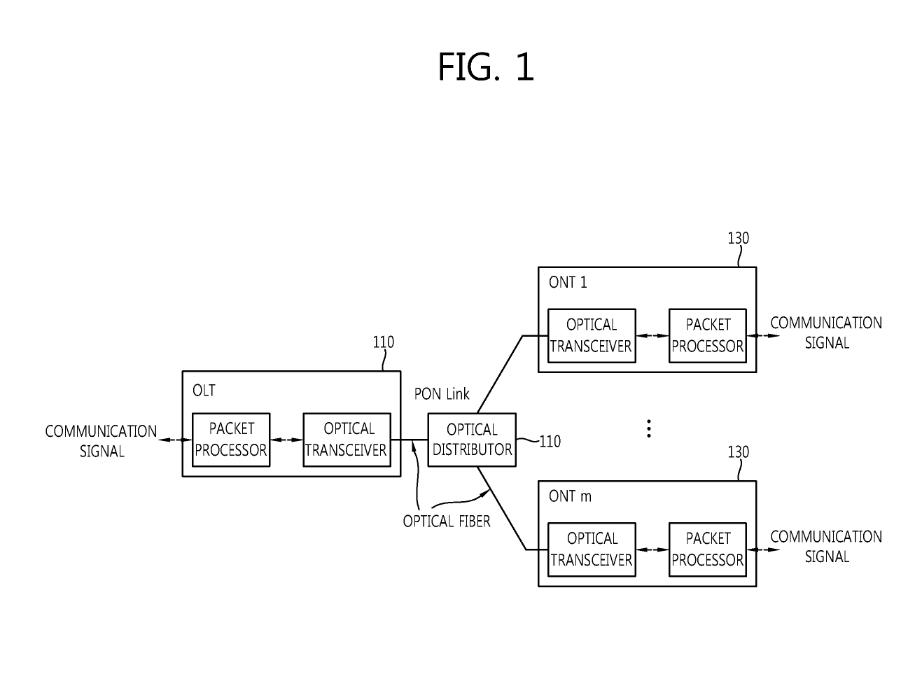

FIG. 1 is a block diagram showing a general PON.

Referring to FIG. 1, the PON includes at least one OLT 110, at least one optical distributor 120, and a plurality of ONTs 130. The OLT 110 transmits broadcasting signals, data signals, voice signals, or the like, to subscribers through a single optical fiber. The OLT 110 may include a packet processor and an optical transceiver. The OLT 110 may be included in a terminal box of a telephone station, a base station, or a residential site. Signals transmitted through the single optical fiber are input to the optical distributor 120. The signals through the optical distributor 120 are branched to the plurality of ONTs 130, respectively. The number of ONTs 130 may be 16, 32, 64, or 128, or more. Each ONT 130 may include the packet processor and the optical transceiver, similar to the OLT 110. Each ONT 130 converts the transmitted optical signals into electrical signals, separates the signals transmitted to the corresponding ONT 130 among the transmitted signals to perform processing on the PON function, and transmits the corresponding signals to subscribers.

When the PON transmits the signals to multiple subscribers, one of the TDM scheme allocating and transmitting the signals that correspond to each subscriber at different time intervals or the wavelength division multiplexing (WDM) scheme allocating and transmitting the signals that correspond to each subscriber at different wavelengths may be applied.

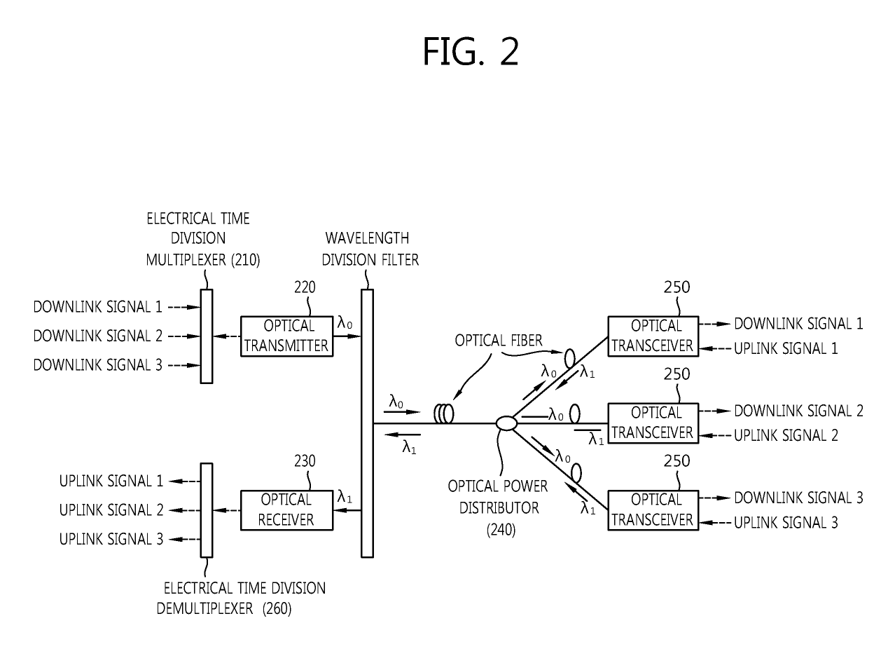

FIG. 2 is a block diagram showing the PON multiplexing signals by the time division multiplexing (TDM) scheme.

First, in a downlink, an electrical time division multiplexer 210 within the OLT converts a plurality of downlink signals transmitted to multiple subscribers into a high-speed single signal. The plurality of downlink signals are allocated in different time domains within the single signal. That is, the plurality of downlink signals is multiplexed by the TDM scheme. An optical transmitter 220 within the OLT modulates the converted single signals into the single optical signal to be transmitted to the subscriber side. In this case, the single optical signal has a single wavelength λ₀ and is transmitted to the subscriber side through an optical fiber via a wavelength division filter.

An optical power distributor 240 distributes the single optical signal to each ONT. Each subscriber converts the optical signals input to each ONT into electrical signals in an optical transceiver 250 and then, selects and receives only the downlink signals corresponding to the subscribers in question. Meanwhile, in an uplink, the time division multiple access (TDMA) scheme is applied. That is, the uplink signals for each subscriber are aligned within the time interval allocated to each subscriber on a temporal axis and the optical transceiver 250 of each subscriber transmits the corresponding uplink signals. The uplink signals of each subscriber multiplexed by the TDMA scheme are transmitted as a single signal having a single wavelength λ₁ and the OLT receives the single signal by the optical receiver 230 and converts the single signal into the uplink signals for each of the plurality of subscribers by an electrical time division demultiplexer 260.

The optical power distributor 240 divides power of the optical signal having the single wavelength so as to be transmitted to each port. Therefore, the same optical signals have power reduced according to the number of ports of the optical power distributor 240 and are each transmitted to the ONT.

Referring to FIG. 2, in the TDM scheme, the OLT uses the single optical transmitter 220 to be able to transmit the signals to all the subscribers and uses the single optical receiver 230 to be able to receive the signals to all the subscribers. Therefore, a network may be built at relatively small costs as compared with other multiplexing schemes. Further, the TDM scheme groups the broadcasting signals or the multicasting signals, which are similarly transmitted to all the subscribers, into a single packet so as to be able to be easily transmitted to all the subscribers. However, multiple subscribers share the transmission band of the uplink and the downlink of the optical transmitter 220 and the optical receiver 230, thereby making the transmitting band narrow. In addition, when the OLT receives the plurality of uplink signals from the multiple subscribers, the strengths and phases of each uplink signal may be different from each other. Therefore, the OLT needs to receive packets in different burst mode types, thereby making the structure of the optical receiver 230 complicated.

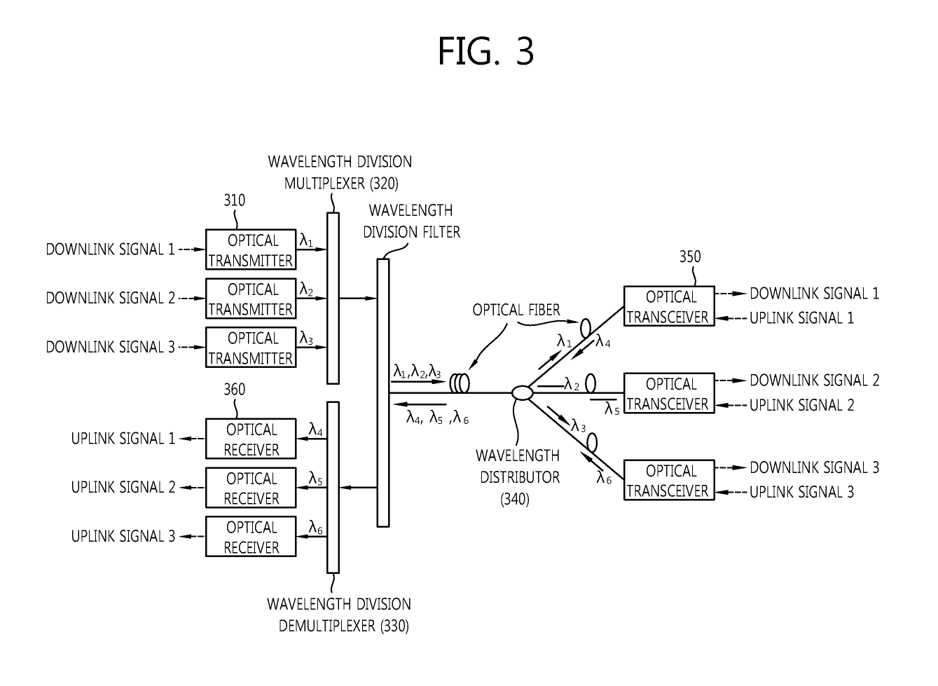

FIG. 3 is a block diagram showing the PON multiplexing signals by the WDM scheme.

First, in the downlink, the plurality of downlink signals are each converted into the optical signals through an optical transmitter 310 within different OLTs for each subscriber. Each optical signal may have different wavelengths. In FIG. 3, it is assumed that the optical signals transmitted to three subscribers each have a wavelength of λ₁, λ₂, and λ₃. The plurality of optical signals having each wavelength are input to the single optical fiber by a wavelength division multiplexer 320 to be transmitted to the subscriber side. The plurality of optical signals is allocated to have different wavelengths within the single optical fiber, such that the plurality of downlink signals may be multiplexed by the WDM scheme. The wavelength distributor 340 distributes the plurality of optical signals having different wavelengths to the corresponding ONTs for each wavelength. Each subscriber converts the optical signals having the corresponding wavelength input to each ONT into electrical signals in the optical transceiver 350 and then, selects and receives only the downlink signals corresponding to the subscribers in question.

Meanwhile, in the uplink, the WDMA scheme is applied. That is, each uplink signal for each subscriber has different wavelengths and the optical transceiver 350 of each subscriber transmits the uplink signals having different wavelengths. In FIG. 3, it is assumed that the optical signals transmitted by three subscribers each have a wavelength of λ₄, λ₅, and λ₄. The uplink signals having different wavelengths are converted into the optical signals by each optical transceiver 350 and are multiplexed according to the WDMA scheme by the wavelength distributor 340 and are input to the single optical fiber to be transmitted to the OLT side. The OLT divides the single signal into the uplink signals having different wavelengths by the wavelength division demultiplexer 330 and the plurality of optical receivers 360 receive the plurality of uplink signals.

For the downlink signals, the wavelength distributor 340 is operated as the wavelength division demultiplexer that outputs the plurality of optical signals having different wavelengths input to the ports connected to the OLTs to the ports connected to multiple subscribers for each wavelength. In addition, for the uplink signal, the wavelength distributor 340 is operated as the wavelength division multiplexer that multiplexes the optical signals having different wavelengths input to each port connected to each subscriber and outputs to a single port to be transmitted to the OLT.

Referring to FIG. 3, in the WDM scheme, the optical transmitter 310 and the optical receiver 360 are allocated to each subscriber within the OLT, such that the WDM scheme may use all the transmission bands of the optical transmitter 310 and the optical receiver 360 of the OLT for each subscriber to transmit or receive the signals. In addition, in the OLT, the packets transmitted from each subscriber have a consecutive mode type, thereby making the circuit of the optical receiver 360 of the uplink signal simple. However, the PON according to the WDM scheme needs the number of optical transmitters 310 and optical receivers 360 of the OLT corresponding to the subscribers, thereby increasing the PON building costs. In addition, the wavelength distributor 340 cannot perform the transmission by the broadcasting and multicasting types, such that the downlink signals required to be transmitted to all the subscribers like broadcasting signals is inefficient in repeatedly transmitting the same signals to each subscriber in the OLT.

As described above, the TDM scheme and the WDM scheme have a trade-off relationship with each other. That is, the advantages of the TDM scheme become the disadvantages of the WDM scheme, and vice versa. Therefore, the PON according to the combination of the TDM scheme and the WDM scheme may be configured. The TDM scheme and the WDM scheme are applied to the same PON, thereby efficiently transmitting the downlink signals and the uplink signals.

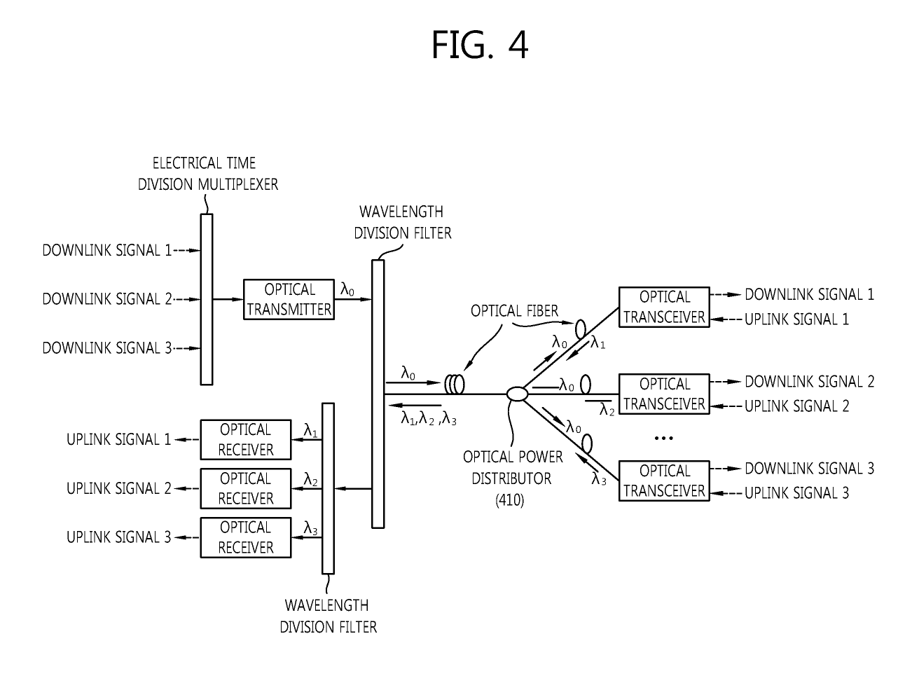

FIG. 4 is a block diagram showing the PON multiplexing signals by the TDM scheme and the WDM scheme. Referring to FIG. 4, the optical power distributor 410 used in the TDM scheme of FIG. 2 may be used as the optical distributor. For the downlink signals, when the optical signals are distributed by the optical power distributor 410, the signals having the same power may be transmitted to all the subscribers, but for the uplink signals, the power of the uplink signals having different wavelengths transmitted from each subscriber is reduced according to the number of ports of the optical power distributor, thereby degrading the efficiency. To the contrary, the wavelength distributor used in the WDMA scheme of FIG. 3 may be used as the optical distributor. When the wavelength distributor is used as the optical distributor, it is difficult to transmit the downlink signal having the single wavelength to all the subscribers. Therefore, in order to efficiently transmit the signals, a new PON architecture is required.

Hereinafter, the proposed invention will be described. The present invention relates to the PON apparatus for transmitting signals between the OLT of a telephone station terminal and the ONT of the subscriber terminal in the optical network. In more detail, according to the PON apparatus proposed by the present invention, the downlink signals transmitted from the OLT to the ONT are multiplexed and transmitted in the TDM scheme and the uplink signals from the ONT to the OLT are divided and transmitted in the WDMA scheme.

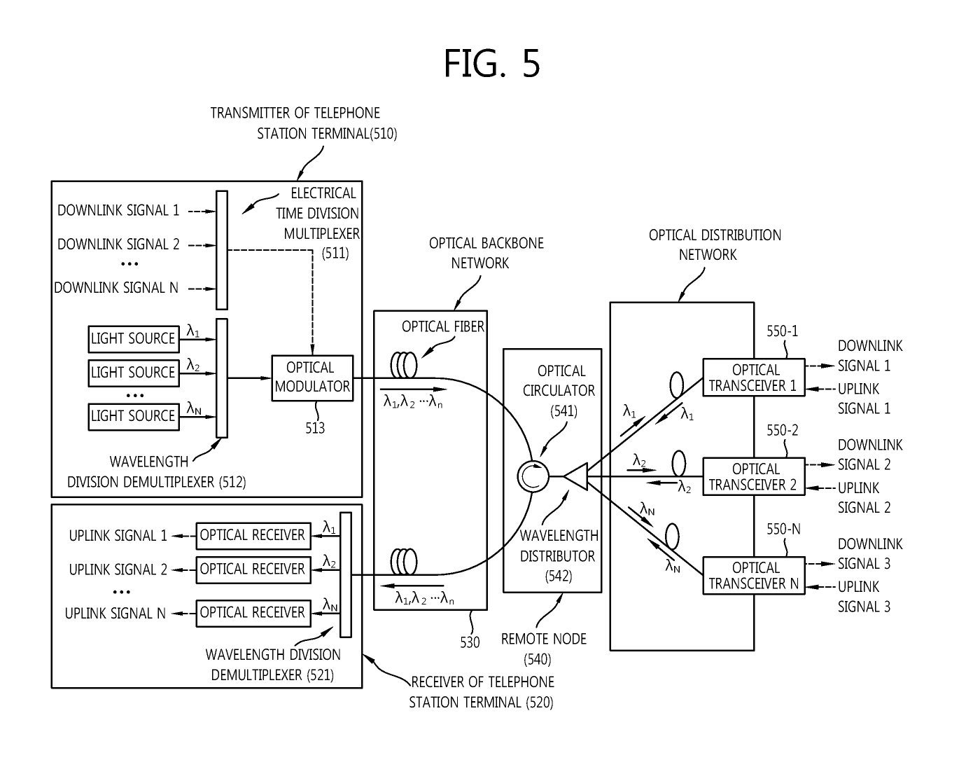

FIG. 5 is an example of a PON apparatus for transmitting optical signals according to the above proposed exemplary embodiments.

Referring to FIG. 5, the PON apparatus of the present invention includes the telephone station terminal, a remote node 540, and a plurality of optical transceivers 550-1, 550-2, . . . , 550-N for the subscriber terminals. The telephone station terminal includes a transmitter 510 and a receiver 520. In addition, as shown in FIG. 5, the PON apparatus of the present invention is operated in the PON in which an optical backbone network including the optical fiber separating the uplink and the downlink, a plurality of optical fibers connecting between multiple subscribers and an optical distribution network including a wavelength distributor 542 are connected to each other by the remote node 540.

First, the transmission of the downlink signals will be described.

The transmitter 510 of the telephone station terminal includes an electrical time division multiplexer 511, a wavelength division multiplexer 512, and an optical modulator 513. The electrical time division multiplexer 511 multiplexes and outputs the plurality of downlink signals into a high-speed single signal. The high-speed single signal becomes the input of the optical modulator 513 to drive the optical modulator 513. The wavelength division multiplexer 512 multiplexes the plurality of light sources to be output through the single optical fiber or a single optical waveguide. The wavelength division multiplexer 512 may use arrayed waveguide grating, or the like. The wavelength division multiplexer 512 uses a WDM light source array including a single multiplexing output port to be connected to the optical modulator 513. When the plurality of light sources having a plurality of wavelengths are multiplexed and input by the wavelength division multiplexer 512, the optical modulator 513 modulates and outputs the multiplexed light sources. The optical modulator 513 is driven by the single signal output from the electrical time division multiplexer 511. The plurality of downlink signals that is subjected to the time division multiplexing by the optical modulator 513 has a plurality of wavelengths and is similarly modulated. Therefore, the optical modulator 513 may detect the same signal even though it receives any one of the wavelengths. The wavelength division multiplexer 512, the optical modulator 513, and the plurality of light sources may be integrated on a single substrate. For example, the plurality of light sources in a chip type, the wavelength division multiplexer 512 connected to each light source, and the optical modulator 513 connected to the output ports of the wavelength division multiplexer 512 may be integrated on a planar lightwave circuit (PLC) platform. Alternatively, the optical modulator may be a Mach Zehnder type rather than the chip type.

Further, the transmitter 510 of the telephone station terminal may include an optical amplifier additionally provided to the output port. The power of the optical signals is amplified by the optical amplifier.

Meanwhile, although the case in which the transmitter 510 of the telephone station terminal multiplexes and transmits the plurality of downlink signals according to the TDM scheme by the electrical time division multiplexer 511 is described above, the above description also includes the case in which the plurality of downlink signals having different wavelengths are modulated and transmitted into the same signal by the electrical time division multiplexer 511.

The plurality of downlink signals passing through the optical modulator 513 are transmitted to an optical circulator 541 of the remote node 540 through a downlink optical backbone network. The optical circulator 541 transmits the plurality of downlink signals to the wavelength distributor 542 of the remote node 540. The optical circulator 541 prevents the downlink signals output from the transmitter 510 of the telephone station terminal from being input to the receiver 520 of the telephone station terminal. The wavelength distributor 542 distributes the plurality of downlink signals to the ports corresponding to each wavelength to be transmitted to the plurality of subscribers, respectively. Each subscriber converts the input optical signals into electrical signals in the optical transceivers 550-1, 550-2, . . . , 550-N) of each ONT and then, selects and receives only the downlink signals corresponding to the subscribers in question. Each optical transceiver 550-1, 550-2, . . . , 550-N may remodulate the downlink signals into the uplink signals.

Hereinafter, the transmission of the uplink signals will be described.

The plurality of uplink signals are transmitted from multiple subscribers, respectively. The plurality of uplink signals are transmitted through the optical transceivers 550-1, 550-2, . . . , 550-N of each ONT and the wavelength distributor 542 receives the plurality of uplink signals. The plurality of uplink signals passing through the wavelength distributor 542 are transmitted to the receiver 520 of the telephone station terminal through the uplink optical backbone network via the optical circulator 541. The optical circulator 541 prevents the plurality of uplink signals input from the wavelength distributor 542 from being input to the transmitter 510 of the telephone station terminal.

The receiver 520 of the telephone station terminal includes the wavelength division demultiplexer 521 and the plurality of optical receivers. The wavelength division demultiplexer 521 demultiplexes each uplink signal transmitted from each subscriber. The wavelength division demultiplexer 521 may apply the arrayed waveguide grating (AWG), or the like. The output ports of the wavelength division demultiplexer 521 are connected to the plurality of optical receivers and the plurality of optical receivers converts the plurality of demultiplexed uplink signals into the electrical signals. In this case, the plurality of optical receivers may include a plurality of photo detector (PD) arrays and the single wavelength division demultiplexer 521. Further, this may be integrated on a single PLC platform. The receiver 520 of the telephone station terminal may further include an optical amplifier additionally provided to the input port.

Similar to the proposed invention, the same PON may effectively apply the TDM scheme and the WDMA scheme. According to the present invention, the downlink signals are transmitted using the optical transmitter and the optical circulator using the plurality of light sources as an input in the telephone station terminal and the multiplexed uplink signals according to the WDMA scheme are received using the plurality of optical receivers, such that the downlink signals having a single wavelength can be transmitted to multiple subscribers when the wavelength distributor is used as the optical distributor in the PON in the TDM scheme. When comparing with the PON in the TDM scheme, the band efficiency of the uplink signals can be increased and the complex circuit for transmitting and receiving the uplink signals can be replaced with a relatively simple circuit. When comparing with the PON in the WDM scheme, the number of optical transmitters is reduced from N to 1 at the time of transmitting the downlink signals to save the costs and the packet transmission in the broadcasting and multicasting types that need to be transmitted to all the subscribers like the broadcasting signals. Further, since the downlink signals are transmitted through the optical backbone network configured of the optical fiber separating the downlink and the uplink, it can be avoided that the transmission of the downlink signals having the same wavelength interferes the uplink signals by being reflected.

The present invention may be implemented by hardware, software, or a combination thereof. The hardware may be implemented as an application specific integrated circuit (ASIC), digital signal processing (DSP), a programmable logic device (PLD), a field programmable gate array (FPGA), a processor, a controller, a microprocessor, other electronic units, or a combination thereof, all of which is designed in order to perform the above-mentioned functions. The software may be implemented as a module performing the above-mentioned functions. The software may be stored in a memory unit and is executed by a processor. The memory unit or the processor may adopt various units that are known to those skilled in the art.

In the above-mentioned exemplified system, although the methods are described based on a flow chart as a series of steps or blocks, the exemplary embodiment of the present invention is not limited to a sequence of steps but any step may be generated in a different sequence or simultaneously from or with other steps as described above. Further, it can be appreciated by those skilled in the art that steps shown in a flow chart is non-exclusive and therefore, include other steps or deletes one or more steps of a flow chart without having an effect on the scope of the exemplary embodiment of the present invention.

As set forth above, the exemplary embodiment of the present invention can increase the band efficiency of the uplink signal and replace a complex circuit for transmitting and receiving the uplink signals with a relatively simple circuit, when compared with the PON in the time division multiplexing (TDM) scheme. The exemplary embodiment of the present invention can reduce the number of optical transmitters from N to 1 when transmitting the downlink signals and reduce costs and can implement the packet transmission in broadcasting and the multicasting types that need to be transmitted to all the subscribers like the broadcasting signals when comparing with the wavelength division multiplexing (WDM) scheme.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A remote node in a passive optical network (PON), comprising:
an optical circulator that transmits downlink signals input from a downlink optical backbone network to a wavelength distributor and transmits uplink signals input from the wavelength distributor to an uplink optical backbone network different from the downlink optical backbone network; and
a wavelength distributor that distributes the downlink signal input from the optical circulator into a plurality of wavelengths to be connected to an optical distribution network and connects the uplink signals input from the optical distribution network to the optical circulator.

2. The remote node of claim 1, wherein the optical circulator blocks the downlink signals input from the downlink optical backbone network from being input to a receiver of a telephone station terminal, and blocks the uplink signals input from the wavelength distributor from being input to a transmitter of the telephone station terminal.

3. The remote node of claim 1, wherein the downlink signal is generated by multiplexing a plurality of downlink signals by a time division multiplexing (TDM) scheme.

4. The remote node of claim 3, wherein the downlink signal is modulated simultaneously with a plurality of optical signals.

5. The remote node of claim 1, wherein the uplink signal is generated by multiplexing a plurality of uplink signals by a wavelength division multiple access (WDMA) scheme.

6. A telephone station terminal in a passive optical network (PON), comprising:
a transmitter and a receiver,
wherein the transmitter includes an electrical time division multiplexer that multiplexes a plurality of downlink signals into a high-speed single signal by a time division multiplexing (TDM) scheme and an optical modulator that modulates a plurality of optical signals simultaneously with the high-speed single signal to be transmitted to be output to a downlink optical backbone network, and
the receiver includes a wavelength division demultiplexer that demultiplexes the uplink signals input from the uplink optical backbone network for each wavelength and a plurality of optical receivers that convert the demultiplexed uplink signals into a plurality of electrical signals, respectively.

7. The telephone station terminal of claim 6, wherein the transmitter of the telephone station terminal further includes a wavelength division multiplexer that multiplexes the plurality of optical signals by a wavelength division multiplexing (WDM) scheme to be output to the optical modulator.

8. The telephone station terminal of claim 7, wherein the wavelength division multiplexer uses an arrayed wave guide (AWG).

9. The telephone station terminal of claim 7, wherein the wavelength division multiplexer is connected to the optical modulator through a WDMA light source array including a single multiplexing output port.

10. The telephone station terminal of claim 7, wherein the plurality of light sources, the wavelength division multiplexer, and the optical modulator are integrated on a planar lightwave circuit (PLC) platform.

11. The telephone station terminal of claim 6, wherein the transmitter of the telephone station terminal further includes an optical amplifier that amplifies the downlink signals output to the downlink optical backbone network.

12. The telephone station terminal of claim 6, wherein the wavelength division demultiplexer of the receiver of the telephone station terminal uses the AWG.

13. The telephone station terminal of claim 6, wherein the receiver of the telephone station terminal is integrated on the PLC platform by a plurality of photo detectors (PDs).

14. The telephone station terminal of claim 6, wherein the receiver of the telephone station terminal further includes an optical amplifier that amplifies the uplink signals input from the uplink optical backbone network.
